(19) United States
(12) Patent Application Publication
(10) Pub. No.: US 2014/0052575 A1
(43) Pub. Date: Feb. 20, 2014

(54) METHOD FOR AUTOMATICALLY GENERATING ELECTRONIC CONTRACT WITH VARIABLE TERMS IN B-to-C E-COMMERCE TRADE

(71) Applicants: Xiao YU, Beijing (CN); Yueting CHAI, Beijing (CN); Yi LIU, Beijing (CN)

(72) Inventors: Xiao YU, Beijing (CN); Yueting CHAI, Beijing (CN); Yi LIU, Beijing (CN)

(73) Assignee: TSINGHUA UNIVERSITY, Beijing (CN)

(21) Appl. No.: 13/970,182

(22) Filed: Aug. 19, 2013

(30) Foreign Application Priority Data
Aug. 20, 2012 (CN) 201210297973.7

(51) Int. Cl. G06Q 30/06

(52) U.S. Cl. CPC G06Q 30/0609
USPC 705/26.35

(57) ABSTRACT

A method for automatically generating an electronic contract with variable terms in a B-to-C e-commerce trade is provided. The method comprises: establishing an electronic contract metadata model; establishing an electronic contract terms library, a rule library of subject matters and terms and a term rule checker; generating an electronic contract template according to the electronic contract metadata model and the optional terms and required terms in the electronic contract terms library; receiving order parameters input by a user and writing the order parameters into the electronic contract template; checking an applicability of terms in the electronic contract template with the written order parameters by the term rule checker according to the rule library of subject matters and terms and the subject matter information, and generating an electronic contract when the checking succeeds; and signing the electronic contract to obtain an effective electronic contract.

### CROSS-REFERENCE TO RELATED APPLICATION

This application claims priority to and benefits of Chinese Patent Application Serial No. 201210297973.7, filed with the State Intellectual Property Office of P. R. China on Aug. 20, 2012, the entire content of which is incorporated herein by reference.

### FIELD

Embodiments of the present disclosure generally relate to a technical field of electronic trade, and more particularly to a method for automatically generating an electronic contract with variable terms in a B-to-C e-commerce trade.

### BACKGROUND

With the popularization of Internet and the rapid development of electronic commerce, B-to-C (Business to Customer) e-commerce websites have gradually become the main ways of shopping online for customers. However, the difficulty for customers to protect their rights on the B-to-C websites has become one important problem to restrict the development of the B-to-C e-commerce. This is because, in e-commerce, the trading partners complete the trade based on the execution of agreement in the trading system without valid contract texts and specific contract terms, when the trade disputes which cannot be solved by the trade system happens, the execution power of the agreement submitted to the judicial department is weak. Therefore, a concept of electronic contract is emerged.

However, for conventional electronic contracts of the B-to-C website, as the trade system belongs to the enterprise and the consumer is just the user of the trade system, the enterprise is in a strong position and the consumer is in a weak position, in which the main feature is that the B-to-C trade adopts an implicit contract with formatted terms. In other words, the B-to-C website lists rights and obligations of trading partners in all the trades, and the consumer can only passively accept them without the rights of modifying them. Furthermore, these formatted terms are not written in any specific contract, and a lot of consumers do not notice these terms until their rights are harmed.

In conclusion, the conventional electronic contracts for the B-to-C website have the following defects:

1. The terms of the conventional electronic contract template are either fully formatted or fully manually input. The fully formatted terms are lack of modifiability, and the fully manually input terms are lack of normalization.

2. The model text of the conventional electronic contracts is lack of sharing mechanism. In the electronic commerce field, there is neither official model text nor sharing mechanism initiated by users.

3. The matching degree between the term content and the subject matter content in the electronic contract is low. This is because, due to the existence of formatted terms, the rights and obligations prescribed by the terms are too wide, which cannot meet the requirement of the contract for the particular commodity or service.

### SUMMARY

Embodiments of the present disclosure seek to solve at least one of the problems existing in the prior art to at least some extent. Therefore, the object of the present disclosure is to provide a method for automatically generating an electronic contract with variable terms in a B-to-C e-commerce trade.

To this end, according to embodiments of the present disclosure, a method for automatically generating an electronic contract with variable terms in a B-to-C e-commerce is provided. The method comprises steps of: establishing an electronic contract metadata model, in which the electronic contract metadata model comprises a basic information metadata model, a trading party information metadata model, a subject matter information metadata model and a variable term metadata model; establishing an electronic contract terms library, a rule library of subject matters and terms and a term rule checker, in which the electronic contract terms library comprises a term information table, a term structure table and a term comment table, the electronic contract terms library stores optional terms and required terms, and the rule library of subject matters and terms indicates a relationship between the subject matters and the terms; generating an electronic contract template according to the electronic contract metadata model, the optional terms and required terms; receiving order parameters input by a user and writing the order parameters into the electronic contract template, in which the order parameters comprise a subject matter information, a trading party information and a contract amount; checking an applicability of terms in the electronic contract template with the written order parameters by the term rule checker according to the rule library of subject matters and terms and the subject matter information, and generating an electronic contract when the checking succeeds; and signing the electronic contract to obtain an effective electronic contract.

According to the method for automatically generating an electronic contract with variable terms in a B-to-C e-commerce trade, by establishing the electronic contract metadata model, the electronic contract terms library and the rule library of subject matters and terms, customizing the electronic contract template and signing the electronic contract, it is possible to customize the electronic contract according to the requirements of the customers, share the standard model terms, freely set the variables of the optional terms, automatically generate the electronic contract, automatically check the effectiveness of the terms and protect the trading evidence, which solve the problems of inflexibility, inequality and hard rights protection of the implicit contract with formatted terms in the B-to-C e-commerce website. Therefore, with the method for automatically generating an electronic contract with variable terms in a B-to-C e-commerce trade, the electronic commerce enterprise has stronger competiveness due to the diversity of the electronic contracts and the convenience of generating the electronic contracts.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the accompanying drawings, in which:

FIG. 1 is a flow chart of a method for automatically generating an electronic contract with variable terms in a B-to-C e-commerce trade according to an embodiment of the present disclosure;

FIG. 2 is a schematic diagram of a working process of a method for automatically generating an electronic contract with variable terms in a B-to-C trade according to an embodiment of the present disclosure;

FIG. 3 is a schematic diagram of an electronic contract metadata model according to an embodiment of the present disclosure;

FIG. 4 is a schematic diagram of a basic information metadata model according to an embodiment of the present disclosure;

FIG. 5 is a schematic diagram of a trading party information metadata model according to an embodiment of the present disclosure;

FIG. 6 is a schematic diagram of a subject matter information metadata model according to an embodiment of the present disclosure;

FIG. 7 is a schematic diagram of an alterable contract items metadata model chart according to the embodiment of the present disclosure;

FIG. 8 is a flow chart of a working process of a term rule checker according to an embodiment of the present disclosure;

FIG. 9 is a flow chart of generating an electronic contract according to an embodiment of the present disclosure; and

FIG. 10 is a flow chart of signing and transmitting an electronic contract according to an embodiment of the present disclosure.

### DETAILED DESCRIPTION

Reference will be made in detail to embodiments of the present disclosure. The embodiments described herein with reference to drawings are explanatory, illustrative, and used to generally understand the present disclosure. The embodiments shall not be construed to limit the present disclosure. The same or similar elements and the elements having same or similar functions are denoted by like reference numerals throughout the descriptions.

It is found that, it is difficult for customers to provide standard and legal terms by themselves, thus a model text of terms is needed. Moreover, in order to protect the rights of the customers, key variables of the terms should be modifiable and settable by the users. Based on the above requirements, a method for automatically generating an electronic contract with variable terms in a B-to-C e-commerce trade is provided according to embodiments of the present disclosure.

In the following, the method for automatically generating an electronic contract with variable terms in a B-to-C e-commerce trade according to embodiments of the present disclosure will be described in detail with the reference of figures.

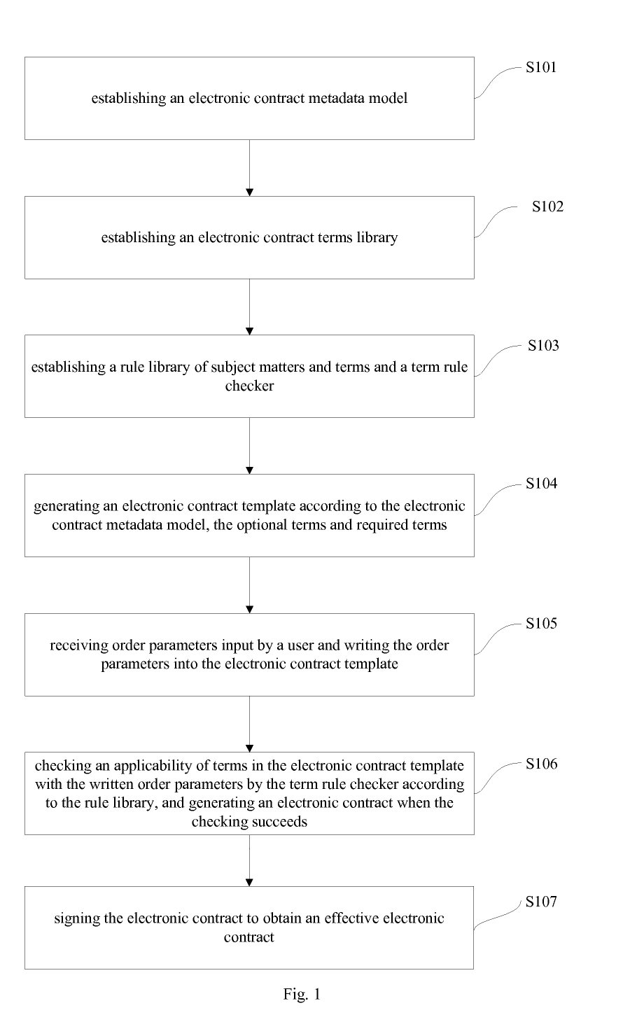

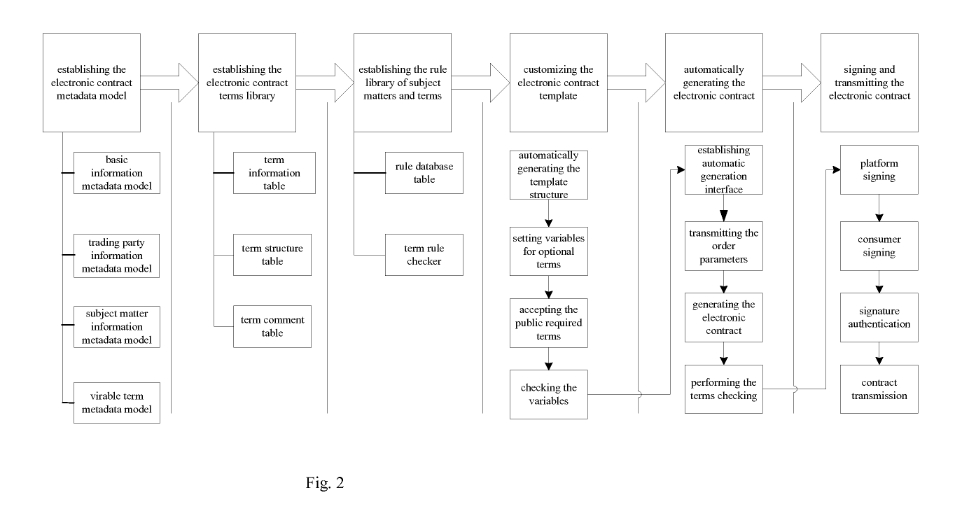

FIG. 1 is a flow chart of a method for automatically generating an electronic contract with variable terms in a B-to-C e-commerce trade according to an embodiment of the present disclosure, and FIG. 2 is a schematic diagram of a working process of a method for automatically generating an electronic contract with variable terms in a B-to-C e-commerce trade according to an embodiment of the present disclosure. As shown in FIG. 1 and FIG. 2, the method of automatically generating an electronic contract with variable terms in a B-to-C e-commerce trade according to embodiments of the present disclosure comprises the following steps.

At step 101, an electronic contract metadata model is established.

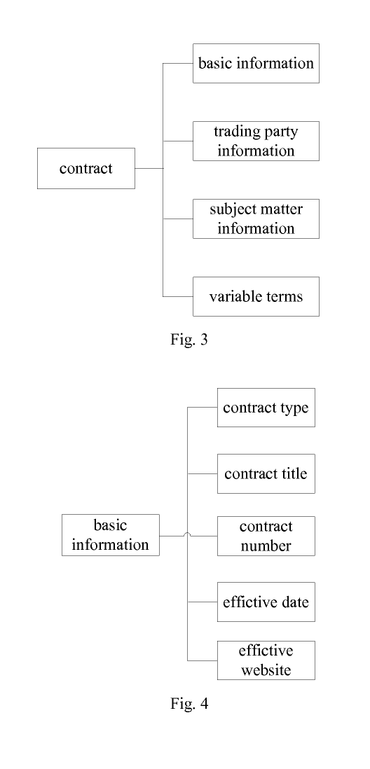

FIG. 3 is a schematic diagram of an electronic contract metadata model according to an embodiment of the present disclosure. As shown in FIG. 3, the electronic contract metadata model comprises a basic information metadata model, a trading party information metadata model, a subject matter information metadata model and a variable term metadata model. In one embodiment of the present disclosure, the electronic contract metadata model may be a XML schema document.

FIGS. 4-7 are schematic diagrams of the basic information metadata model, the trading party information metadata model, the subject matter information metadata model and the variable term metadata model respectively.

As shown in FIG. 4, the basic information metadata model comprises necessary information indicating the uniqueness and legality of the electronic contract, such as a contract type, a contract title, a contract number, a signing date, an effective date and an effective website. The contract number is a globally unique number of the electronic contract.

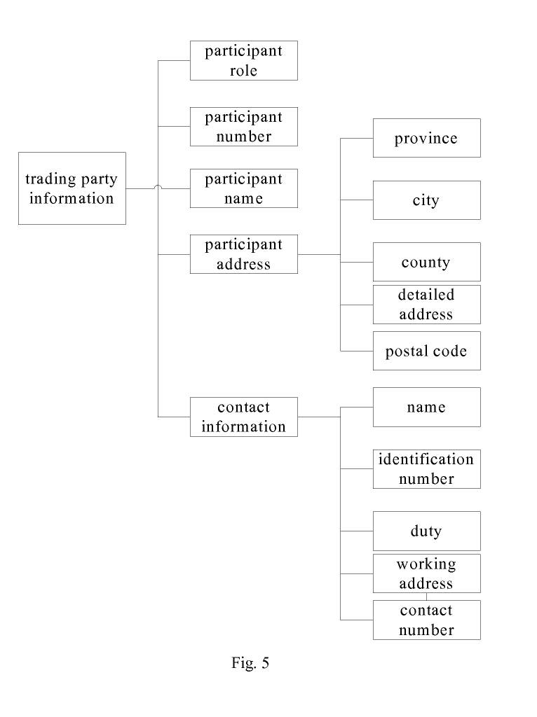

The trading parties must comprise a first party and a second party, and may also comprise some third parties. Since the trading parties of signing a contract may be an enterprise entity, a natural person or various institutions, the information of the trading parties are expressed with a participant information and a contact information. As shown in FIG. 5, the trading party information metadata model comprises the participant information and the contact information. The participant information comprises at least a participant role, a participant number, a participant name and a participant address. The participant role indicates whether the participant is the first party or the second party. The participant number refers to the information of a corporation institution or the identification number of a natural person. The participant name refers to the name of the corporation institution or the name of the natural person. The participant address refers to the registered address of the corporation institution or the contact address of the natural person.

The contact information refers to the information of a natural person signing the electronic contract on the behalf of the corporation institution or a natural person as a party of the electronic contract, and the contact information may comprise a name, an identification number, a duty, a working address and a contact number.

When the electronic contract is signed by a corporation institution, the participant information is the information of the corporation institution, the contact information is the information of the natural person signing the electronic contract, and both of them are indispensable. When the electronic contract is signed by a natural person signs a contract, the participant information and the contact information are the same, the participant number is the identification number of the natural person, and the participant name is the name of the natural person.

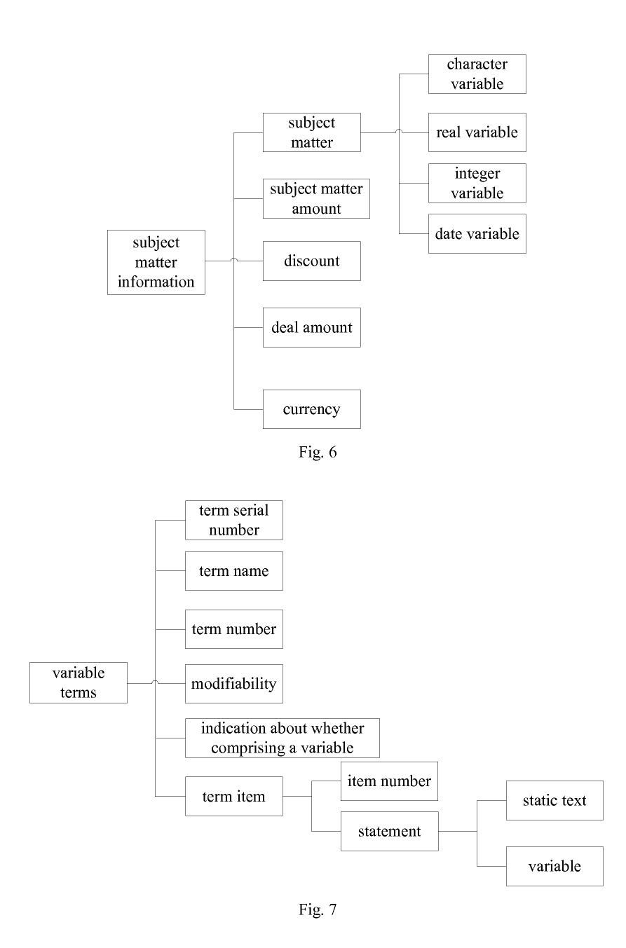

As shown in FIG. 6, the subject matter information is used to describe the information of the subject matter in the e-commerce trade, and the subject matter information metadata model comprises a subject matter, a subject matter amount, a discount, a deal amount and a currency. The subject matter is a property set of a product, each property is described with variables, and the variables comprises a character variable describing text writing of the product (such as, a product name, a product category, a product specification, and an intellectual property information of the product), a real variable describing real properties of the product (such as, the price of the product, and the amount of the product), an integer variable describing integer properties of the product (such as, the number of the product), and a date variable describing date properties of the product (such as, the production date or the expiration date of the product).

As shown in FIG. 7, the variable term metadata model comprises a term property and a term item. The term property comprises a term serial number, a term name, a term number, a modifiability, an indication about whether the term comprises a variable and a term category. The term item is constituted with an item number and some statements, and each term item is corresponding to a unique item number. The statement is constituted with some static texts and variables, the static text refers to the text without variable contents, and the variables of the statement are the text contents which may be modified. The variables of the statement are the same with the variables of the subject matter information metadata model.

At Step 102, an electronic contact terms library is established by an application server of the B-to-C website.

In one embodiment of the present disclosure, the electronic contract terms library is established based on the following implementation environment and technology:

database: Oracle 10 g

persistence layer: Hibernate 3.3

page layout technology: Jsp+Structs 2.0

operation structure: Spring 3.5

application server: Tomcat 1.6.0

JRE: 1.6.2

Specifically, the electronic contract terms library established by the application server of the B-to-C website comprises a term information table, a term structure table and a term comment table.

Table 1 is a schematic illustration of the term information table according to an embodiment of the present disclosure. As shown in Table 1, basic properties of the term information table comprises at least a term serial number, a user name of the user releasing terms, a term name, a term category, a term description, a establishing time and a term number. The term category comprises an optional term and a required term.

TABLE 1
term information table

| physical name | data type | note |
|---|---|---|
| SERIALNO | Varchar 40 | term serial number (major key) |
| UESERNAME | Varchar 40 | user name of the user releasing |
| | | terms (foreign key) |
| NAME | Varchar 100 | term name |
| CATEGORY | Varchar 20 | term category |
| DESCRIPTION | Varchar 1000 | term description |
| CREATTIME | Date | establishing time |
| CODE | Varchar 20 | term number |

Table 2 is a schematic illustration of a term structure table according to an embodiment of the present disclosure. As shown in Table 2, basic properties of the term structure table comprises at least a statement serial number, a serial number of the term to which the statement belongs (a term serial number for short), an indication about whether the term comprises a variable, a static text, a variable type, a variable name, a variable value, a statement sequence number, a previous statement and a next statement.

TABLE 2
term structure table

| physical name | data type | note |
|---|---|---|
| SERIALNO | Varchar 40 | statement serial |
| | | number (major key) |
| CLAUSENO | Varchar 40 | term serial number |
| | | (foreign key) |
| HASVARIABLE | Varchar 10 | indication about whether |
| | | the term comprises a |
| | | variable |
| TEXT | Varchar 2000 | static text |
| VARIABLETYPE | Varchar 20 | variable type |
| VARIABLENAME | Varchar 50 | variable name |
| VALUE | Varchar 200 | variable value |
| SEQUENCENO | Varchar 5 | statement sequence |
| | | number |
| LASTSTATEMENTMENT | Varchar 40 | previous statement |
| NEXTSTATEMENTMENT | Varchar 40 | next statement |

Table 3 is a schematic illustration of the term comment table according to an embodiment of the present disclosure. As shown in Table 3, basic properties of the term comment table comprises at least a comment serial number, a term serial number, a user name of the user publishing comments, a comment content and a comment time.

TABLE 3
term comment table

| physical name | data type | note |
|---|---|---|
| SERIALNO | Varchar 40 | comment serial number (major key) |
| CLAUSENO | Varchar 40 | term serial number (foreign key) |
| UESERNAME | Varchar 40 | user name of the user publishing |
| | | comments (foreign key) |
| CONTENT | Varchar 2000 | comment content |
| DATE | DATE | comment time |

At Step 103, a rule library of subject matters and terms and a term rule checker are established.

In one embodiment of the present disclosure, basic properties of the rule library comprises at least a rule serial number, a term serial number, a subject matter serial number, a rule type, a rule name, a rule explanation and an update time. The rule type comprises an acceptance rule and a refusal rule.

Table 4 is a schematic illustration of the rule library according to an embodiment of the present disclosure. As shown in Table 4, the rule library establishes a relationship between the subject matters and the terms, and the relationship may be an applicable acceptance relationship or a conflict refusal relationship.

TABLE 4
rule library of subject matters and terms

| physical name | data type | note |
|---|---|---|
| SERIALNO | Varchar 40 | rule serial number (major key) |
| CLAUSENO | Varchar 40 | term serial number (foreign key) |
| PRODUCTNO | Varchar 40 | subject matter serial number |
| | | (foreign key) |
| RULETYPE | Varchar 20 | rule type, comprising: an acceptance |
| | | rule and a refusal rule |
| RULENAME | Varchar 50 | rule name |
| DESCRIPTION | Varchar 1000 | rule explanation |
| UPDATETIME | Date | update time |

The term rule checker is used to check an applicability of the subject matters and rules input by the user according to the rule library, which will be described in detail hereinafter.

At Step 104, an electronic contract template is generated according to the electronic contract metadata model and the optional terms and required terms in the electronic contract terms library.

In one embodiment, the electronic contract template is generated as follows.

Firstly, an electronic contract template structure is automatically generated according to the electronic contract metadata. Specifically, by analyzing the electronic contract metadata model, the tag structure of the electronic contract template structure is established. In one embodiment of the present disclosure, the electronic contract template structure may be a XML document, the tag structure of the electronic contract template structure comprises all the legal and required tags, and the tag content is null.

Secondly, an objective term is selected from the optional terms and added into the electronic contract template structure, an XML tag of the objective term is generated automatically and inserted into the electronic contract template structure, and values of all the variables of the objective term are set. Specifically, the user chooses the objective term by the term browsing interface and adds the objective term into the electronic contract template structure, and meanwhile the user sets the variable values of the objective term according to requirements. During the process of choosing the objective term, data in the term structure table should be converted into the tag structure satisfied with the specification of the Schema document. In one embodiment of the present disclosure, the conversion rule is that each data record of the term structure table is converted into a tag for the term statement.

Thirdly, the public required terms set by the B-to-C e-commerce enterprises are automatically added into the electronic contract template, and the user chooses whether to accept the public required terms. When the user chooses not to accept the public required terms, the user inputs the refusal reasons and it returns to the electronic contract template structure generation step. When the user chooses to accept the public required terms, the following steps are implemented.

Specifically, the public required terms are a set of formatted terms set by the B-to-C website based on the consideration of enterprise interests. The set of formatted terms must be added into the electronic contract template and the following operation can be performed only when the set of formatted terms are added into the electronic contract template. However, the users have the rights to choose to accept or refuse the set of formatted terms. When the user refuses the formatted terms, the user is required to write the refusal reasons, such as which term is refused. Each refusal reason forms a complaint, and the B-to-C website is required to deal with each complaint in a limited time. Thus, a negotiation mechanism between the consumers and the B-to-C website is formed.

Finally, the variables of the objective term are checked and the electronic contract template is generated and stored when the checking of variables of the objective term succeeds. In one embodiment of the present disclosure, it is checked whether the values of all the variables of the objective term satisfy with a predetermined variable type.

Specifically, the system checks all the variables of the electronic contract template after the user accepts the public terms. When there is one or more variable exceeding the predetermined scope, then the system gives an alarm and returns to the step of choosing objective term and setting variables of the objective term. When the checking of all the variables succeeds, the electronic contract template is successfully generated, saved as a file and stored in a database.

It should be understood that the terms in the electronic contract template may be adjusted and modified.

At Step 105, order parameters input by the user are received and written into the electronic contract template.

Specifically, an electronic contract generation interface is firstly established by means of the Web Service technology. The electronic contract generation interface is used to be called when an order is generated and to be input order parameters. In embodiments of the present disclosure, the order parameters comprise a subject matter information, a trading party information and a contract amount, and the electronic contract generation interface can receive a returned electronic contract text after the electronic contract is generated.

The electronic contract generation interface service requires the fact that the user has already had an effective electronic contract template in the server, and the service will generate the electronic contract according to the electronic contract template specified by the user. The user is required to input the parameters according to the requirements of interface parameters. The interface parameters comprise at least the subject matter information, the trading party information and the contract amount, and the electronic contract generation interface returns the electronic contract text.

An exemplifying explanation of the electronic contract generation interface is as follows:

interface name: generateContract

interface parameters:
String username, //service interface username
String password, //service interface password
String template_name, //contract template name
String Contract Name, //contract name, non-null;
String Site_DN //domain name of the electronic commerce trade platform;
String Order_No //order number, non-null;
PartyInfo partyOne, //information of the first party (B-to-C platform), non-null;
PartyInfo partyTwo, //information of the second party (the consumer), non-null;
List<DrugInfo> drugList, //list of subject matters, non-null;
String contact_Amount, //total contract value, non-null, up to two digits after the decimal point;

return value:

string type, if the service is normal, returning the electronic contract number; if the service is abnormal, returning an error.

Secondly, the B-to-C website adds an agent client of the electronic contract generation interface in the order generation functional module, and when the order is generated in the order generation functional module, the electronic contract generation interface is called by the agent client, and then the order parameters are passed to the electronic contract generation interface.

Finally, the validity of the parameters input to the electronic contract generation interface is checked, and then the parameters checked to be valid are written into the electronic contract template.

At Step 106, an applicability of terms in the electronic contract template with the written order parameters are checked by the term rule checker, when the checking succeed, the electronic contract is generated and stored, or else, returning to the step of receiving order parameters.

FIG. 8 is a flow chart of a working process of a term rule checker according to an embodiment of the present disclosure. As shown in FIG. 8, the applicability checking comprises the following steps.

At step 801, the terms of the electronic contract template are read.

At step 802, the subject matters of the electronic contract template are read.

At step 803, the subject matters and the terms are combined to obtain a plurality of pairs of subject matter and term. In other words, the subject matters and the terms are iterated.

At step 804, one pair of subject matter and term is selected to go through rules in the rule library.

Each pair of subject matter and term should go through all the rules in the rule library.

At step 805, it is judged whether the pair of subject matter and term has the conflict refusal relationship, if yes, execute step 806, and if no, return to step 804.

If the pair of subject matter and term has the applicable acceptance relationship or does not have the conflict refusal relationship after going through all the rules, return to step 804 to check the next pair of subject matter and term until all the pairs of subject matter and term are checked.

At step 806, a conflict is reported and the checking is stopped.

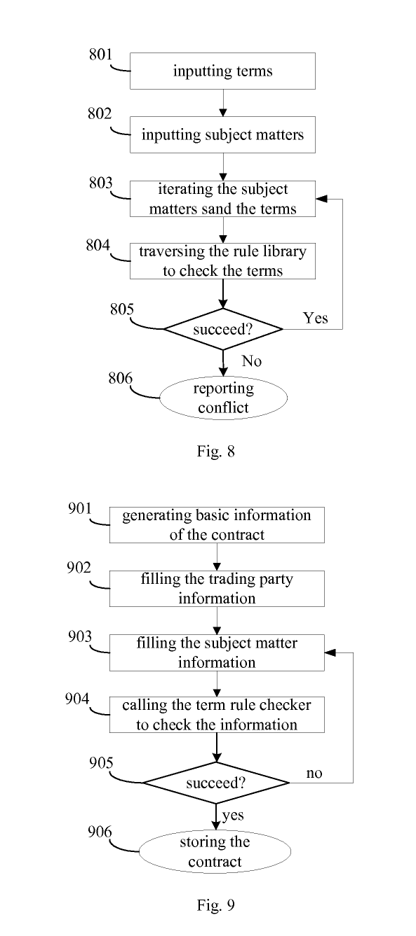

FIG. 9 is a flow chart of generating an electronic contract according to an embodiment of the present disclosure. As shown in FIG. 9, generating the electronic contract comprises the following steps.

At step 901, the basic information of the electronic contract is generated.

In one embodiment of the present disclosure, the basic information of the electronic contract may be the electronic contract number, the electronic contract name, the electronic contract category, the trade website and so on.

At step 902, the trading party information is filled.

The trading party information transmitted from the electronic contract generation interface is written into the electronic contract template.

At step 903, the subject matter information is filled.

The subject matter information transmitted from the electronic contract generation interface is written into the electronic contract template.

At step 904, the term rule checker is called to check the information.

At step 905, it is judged whether the checking of the information succeeds, if yes, execute step 906, or else, return to step 902.

Specifically, the subject matter information and the term information are input into the term rule checker to check whether there is conflict refusal relationship, if no, execute step 906, and if yes, report the conflict and return to step 902.

At step 906, the electronic contract is generated and stored.

The electronic contract is generated and the contract number is returned.

At step 107, the electronic contract is signed to obtain an effective electronic contract.

When the user clicks “submit the order”, the automatically generated electronic contract is input into the signature and security transmission function module. The electronic contract is firstly signed by the B-to-C e-commerce trade platform and then signed by the user.

Specifically, during the order submitting process, the electronic commercial enterprise digitally signs the electronic contract by a digital signature interface and an encryptor provided by a third party digital certification center according to a digital certificate of the B-to-C e-commerce website to obtain a first signed electronic contract.

Then, after the digital signature plug-in is downloaded and installed by the user client browser, the first signed electronic contract is transmitted to the client browser and digitally signed by the signature plug-in according to a digital certificate of the user. The electronic contract is made effective after both trade participants have made the signature. Then, the effective electronic contract is transmitted to the B-to-C website for store, and the user may also save the effective electronic contract.

In one embodiment of the present disclosure, the signatures of the effective electronic contract may be verified. Specifically, the effective electronic contract may be verified by a verification interface provided by the B-to-C website, or by a downloaded verification client application.

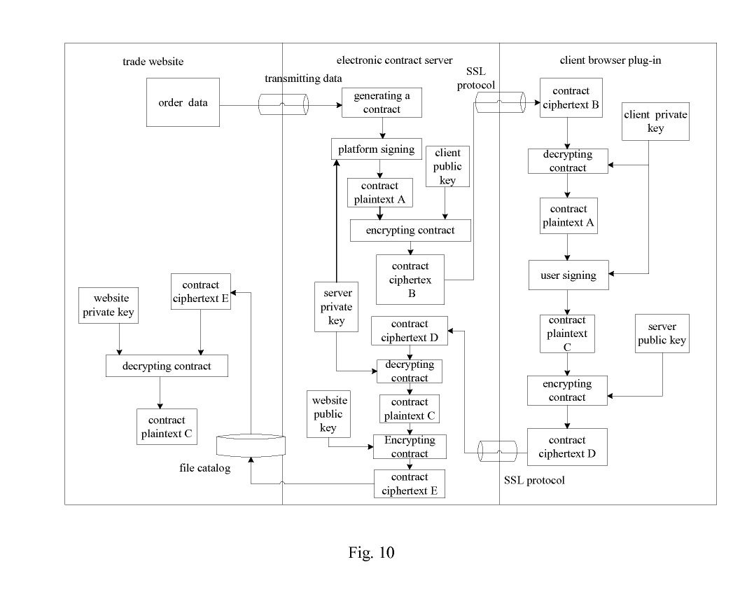

In the following, the above signature and security transmission process will be described in detail with reference to FIG. 10.

As shown in FIG. 10, the contract plaintext A is the contract signed by the trade platform, the contract ciphertext B is the ciphertext obtained from encrypting the contract plaintext A with the public key of the client, the contract plaintext C is the contract signed by the user, the contract ciphertext D is the ciphertext obtained from encrypting the contract plaintext C with the public key of the system server, and the contract ciphertext E is the ciphertext obtained from encrypting the contract plaintext C with the public key of the trade website.

Specifically, the server generates the electronic contract according to the order parameters transmitted from the B-to-C website, and obtains the contract plaintext A by the trade platform signing the contract. The contract plaintext A is encrypted with the public key of the client to obtain the contract ciphertext B, and then the contract ciphertext B is transmitted to the client browser plug-in using the SSL protocol.

The client browser plug-in decrypts the contract ciphertext B with the private key of the client to obtain the contract plaintext A. The contract plaintext A is signed with the private key of the client to obtain the contract plaintext C, and then the contract plaintext C is encrypted with the public key of the server to obtain the contract ciphertext D. The client browser plug-in transmits the contract ciphertext D to the server using the SSL protocol. The server decrypts the contract ciphertext D with the private key of the server to obtain the contract plaintext C, and then encrypts the contract plaintext C with the public key of the trade website to obtain the contract ciphertext E. The server transmits the contract ciphertext E to the file directory of the B-to-C trade website. The contract ciphertext E is decrypted by the private key of the trade website to obtain the contract plaintext C.

According to the method for automatically generating an electronic contract with variable terms in a B-to-C e-commerce trade, by establishing the electronic contract metadata model, the electronic contract terms library and the rule library of subject matters and terms, customizing the electronic contract template and signing the electronic contract, it is possible to customize the electronic contract according to the requirements of the customers, share the standard model terms, freely set the variables of the optional terms, automatically generate the electronic contract, automatically check the effectiveness of the terms and protect the trading evidence, which solve the problems of inflexibility, inequality and hard rights protection of the implicit contract with formatted terms in the B-to-C e-commerce website. Therefore, with the method for automatically generating an electronic contract with variable terms in a B-to-C e-commerce trade, the electronic commerce enterprise has stronger competiveness due to the diversity of the electronic contracts and the convenience of generating the electronic contracts.

In the flow chart or any process or method description described with other manner may be construed to means including one or more modulate, segment and parts of the available code of the procedure of the process or for realizing a certain logical function, and the scope of the actualizing scheme selected preferentially of the present disclosure includes other actualization, and the function may be implemented with the basic coinstantaneous method or the contrary order, according to the related function, and the function may be not implemented as the order showed or discussed, which is understood by those skilled of the technical field of the embodiments of the present disclosure.

The logic and/or procedure described with other manner or showed in the flow chart, for example, may be considered to be the sequencer list for executing the instruction for realizing the logical function, concretely actualized in the readable medium in any computer to be used by the instruction execution system, device and equipment (such as the system based on the computer, the system including a processor and other system for fetching the instruction and executing the instruction from the instruction execution system, device and equipment), or used with the instruction execution system, device and equipment. As to the specification, “the readable medium in any computer” may be any device, and the device may include, store, communicate, diffuse or transmit procedure to be used by the instruction execution system, device and equipment or the device is used with the instruction execution system, device and equipment. The more concrete demonstration of the readable medium in any computer (the limited list) comprises: an electronic connection (an electronic device) with one or more wires, a portable computer box (a magnetism device), a random-access memory (RAM), a read-only memory (ROM), a erasable-programmable read-only memory (EPROM or flash memory), a optical fiber device and a portable compact disk read-only memory (CDROM). In addition, the readable medium of computer is even a paper or other appropriate medium to print the procedure on it, because the procedure obtained with electronic form may be edited, decrypted or dealt with other appropriate manner by optical scanning the paper or other medium, and then the procedure worked will be stored in the computer memory.

It is understood that each part of the present disclosure may be actualized by the hardware, software, firmware or their assembly. In the actualization manner, a plurality of procedure or manner may be actualized by the software or firmware, and the software or the firmware are stored in the memory and executed by the appropriate instruction execution system. For example, if the procedure or manner is actualized by the hardware, as the same as another actualization manner, the procedure or manner may be actualized by one of the following techniques of the field known to all or their assembly: a discrete logic circuit of the logic gate circuit for actualizing logic function to data signal, a special integrate circuit having an appropriate combination logic gate circuit, programmable gate array (PGA), field programmable gate array (FPGA) and so on.

All or parts of the procedure schlepped in the method for actualizing the embodiments of the present disclosure are understood by those common skilled of the technical field, which is achieved by the hardware dictated by the procedure. The procedure may be stored in a computer readable storage medium, and the procedure includes one of the procedures of the embodiments of the present disclosure or their assembly when it is actualized.

In addition, each function cell of the embodiments of the present disclosure may be integrated into a processing module, and these cells may physically exist respectively, and also two or plural of the cells are integrated into a processing module. The integrated module is not only actualized with the hardware, but also actualized with the software function module. When the integrated module is actualized with the software function module to be sold or used as an unattached production, the integrated module may be stored in a computer readable storage medium.

The storage medium mentioned above may be read-only memory, disk or CD.

Reference throughout this specification to “an embodiment,” “some embodiments,” “an example,” “a specific example,” or “some examples,” means that a particular feature, structure, material, or characteristic described in connection with the embodiment or example is included in at least one embodiment or example of the present disclosure. The appearances of the phrases throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

What is claimed is:

1. A method for automatically generating an electronic contract with variable terms in a B-to-C e-commerce trade, comprising steps of:
establishing an electronic contract metadata model, wherein the electronic contract metadata model comprises a basic information metadata model, a trading party information metadata model, a subject matter information metadata model and a variable term metadata model;
establishing an electronic contract terms library, a rule library of subject matters and terms and a term rule checker, wherein the electronic contract terms library comprises a term information table, a term structure table and a term comment table, the electronic contract terms library stores optional terms and required terms, and the rule library of subject matters and terms indicates a relationship between the subject matters and the terms;
generating an electronic contract template according to the electronic contract metadata model, the optional terms and required terms;
receiving order parameters input by a user and writing the order parameters into the electronic contract template, wherein the order parameters comprise a subject matter information, a trading party information and a contract amount;
checking an applicability of terms in the electronic contract template with the written order parameters by the term rule checker according to the rule library of subject matters and terms and the subject matter information, and generating an electronic contract when the checking succeeds; and
signing the electronic contract to obtain an effective electronic contract.

2. The method according to claim 1, wherein generating an electronic contract template according to the electronic contract metadata model and the optional terms and required terms in the electronic contract terms library comprises:
generating an electronic contract template structure according to the electronic contract metadata model;
selecting an objective term from the optional terms, adding the objective term into the electronic contract template structure, and setting values of variables of the objective term;
generating a tag of the objective term and inserting the tag of the objective term into the electronic contract template structure;
adding the required terms into the electronic contract template structure;
checking whether the values of variables of the objective term satisfy a predetermined variable type; and
if yes, generating and storing the electronic contract template.

3. The method according to claim 1, wherein the relationship between the subject matters and the terms comprises an applicable acceptance relationship and a conflict refusal relationship.

4. The method according to claim 1, wherein receiving order parameters input by a user and writing the order parameters into the electronic contract template, wherein the order parameters comprise a subject matter information comprises:
establishing an electronic contract generation interface;
calling the electronic contract generation interface by an agent client when an order is generated in a B-to-C website, and passing the order parameters to the electronic contract generation interface;
checking whether the order parameters are effective; and
if yes, writing the order parameters into the electronic contract template.

5. The method according to claim 3, wherein checking an applicability of terms in the electronic contract template with the written order parameters by the term rule checker according to the rule library of subject matters and terms and the subject matter information comprises:
reading the subject matters and terms in the electronic contract template;
combining the subject matters and terms to obtain a plurality of pairs of subject matter and term;
checking each rule in the rule library of subject matters and terms for each pair of subject matter and term;
judging whether the each pair of subject matter and term has the conflict refusal relationship;
if yes, reporting conflicts and stopping checking; and
if no, the checking succeeds.

6. The method according to claim 1, wherein signing the electronic contract comprises:
digitally signing the electronic contract by a digital signature interface and an encryptor provided by a third party digital certification center according to a digital certificate of the B-to-C website to obtain a first signed electronic contract;
transmitting the first signed electronic contract to a user browser, and digitally signing the first signed electronic contract by a signature plug-in according to a digital certificate of the user to obtain the effective electronic contract; and
transmitting the effective electronic contract to the B-to-C website for storage.

7. The method according to claim 6, further comprising:
encrypting the effective electronic contract by an asymmetric encryption method.

8. The method according to claim 6, further comprising:
verifying the signatures of the effective electronic contract by a verification interface or a verification client application provided by the B-to-C website.

9. The method according to claim 1, wherein the terms in the electronic contract template is adjustable and adaptable.

10. The method according to claim 1, wherein the electronic contract metadata model is a XML Schema document.

11. The method according to claim 1, wherein the electronic contract template is a XML document.
